(19) United States
(12) Patent Application Publication
(10) Pub. No.: US 2016/0288695 A1
(43) Pub. Date: Oct. 6, 2016

(54) RETAINING DEVICE AND METHODS OF USING THE SAME

(71) Applicants: Mark Oliver MINTY, Shelby Township, MI (US); Andrew Douglas MINTY, Lake Orion, MI (US)

(72) Inventors: Mark Oliver MINTY, Shelby Township, MI (US); Andrew Douglas MINTY, Lake Orion, MI (US)

(21) Appl. No.: 15/085,495

(22) Filed: Mar. 30, 2016

Related U.S. Application Data
(60) Provisional application No. 62/140,099, filed on Mar. 30, 2015.

(51) Int. Cl. B60P 7/08; A44B 18/00

(52) U.S. Cl. CPC B60P 7/0892; A44B 18/0023

(57) ABSTRACT

A retaining device and methods of using the same for securing at least one predetermined object when a vehicle is in motion is provided. The retaining device will provide a shell, a detachable closure mechanism, an insert medium or pad, and a removable fastener. The shell provides a pouch opening communicating to an internal compartment, the opening being movable between a closed condition and an open condition by way of the detachable closure mechanism. The internal compartment is adapted to snugly receive the insert medium, thereby providing bulk and shock absorption to trap and cushion the at least one predetermined object. The removable fastener closure device is provided by the shell for securing the retaining device in or on a portion of the vehicle adjacent to the at least one predetermined object.

### CROSS-REFERENCE TO RELATED APPLICATION

This application claims the benefit of priority of U.S. provisional application No. 62/140,099, filed 30 Mar. 2015, the contents of which are herein incorporated by reference.

### BACKGROUND OF THE INVENTION

The present invention relates to retaining devices and, more particularly, a retaining device that is small, lightweight, portable, inexpensive, and adaptable to easily attach in almost any vehicle to securely retain loose objects when the vehicle is in motion.

When a vehicle is in motion loose objects tend move around due to forces caused by braking, turning, or accelerating. Such movement may result in damage to those loose objects and/or the inside of the vehicle. Other retaining devices are bulky, heavy, and/or vehicle specific, driving costs up and limiting adaptability. Moreover, other retaining devices are complex, not easily portable, and/or need to be mechanically attached to the vehicle to prevent loose object from moving when vehicle is in motion. These mechanical attachments are usually time consuming and may damage the vehicle and/or lower its resale value. Some currently used retaining devices may result in damage to the loose objects. For example, if the loose objects are merely housed in the retaining device, wherein they can still move around.

As can be seen, there is a need for a retaining device that is small, lightweight, portable, inexpensive, and adaptable to easily attach to almost any vehicle to securely retain loose objects when the vehicle is in motion.

### SUMMARY OF THE INVENTION

In one aspect of the present invention, a retaining device includes a shell defining an internal compartment and an opening communicating thereto; a detachable closure mechanism provided along a periphery of the opening; an insert medium snugly received in the internal compartment; and a removable fastener disposed along an outer portion of the shell.

In another aspect of the present invention, the retaining device includes a shell defining an internal compartment and an opening communicating thereto; a detachable closure mechanism provided along a periphery of the opening; an expandable foam snugly received in the internal compartment; a hook and loop fastener disposed along an outer portion of the shell; and a tab provided by the detachable closure for facilitating moving the opening between a closed condition and an open condition, making the internal compartment accessible.

In yet another aspect of the present invention, a method of retaining a predetermined object within a moving vehicle includes the steps of providing the first retaining device; selectively positioning the first retaining device so as to abut a first side of the predetermined object; and securing a first removable fastener to an internal surface of the vehicle, wherein the internal surface operatively engages the removable fastener

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in an exemplary use;

FIG. 2 is a top perspective view of an exemplary embodiment of the present invention;

FIG. 3 is a lower perspective view of an exemplary embodiment of the present invention; and

FIG. 4 is a section view of an exemplary embodiment of the present invention, taken along line 4-4 in FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a retaining device and methods of using the same for securing at least one predetermined object when a vehicle is in motion. The retaining device will provide a shell, a detachable closure mechanism, an insert medium or pad, and a removable fastener. The shell provides a pouch opening communicating to an internal compartment, the opening being movable between a closed condition and an open condition by way of the detachable closure mechanism. The internal compartment is adapted to snugly receive the insert medium, thereby providing bulk and shock absorption to trap and cushion the at least one predetermined object. The removable fastener closure device is provided by the shell for securing the retaining device in or on a portion of the vehicle adjacent to the at least one predetermined object.

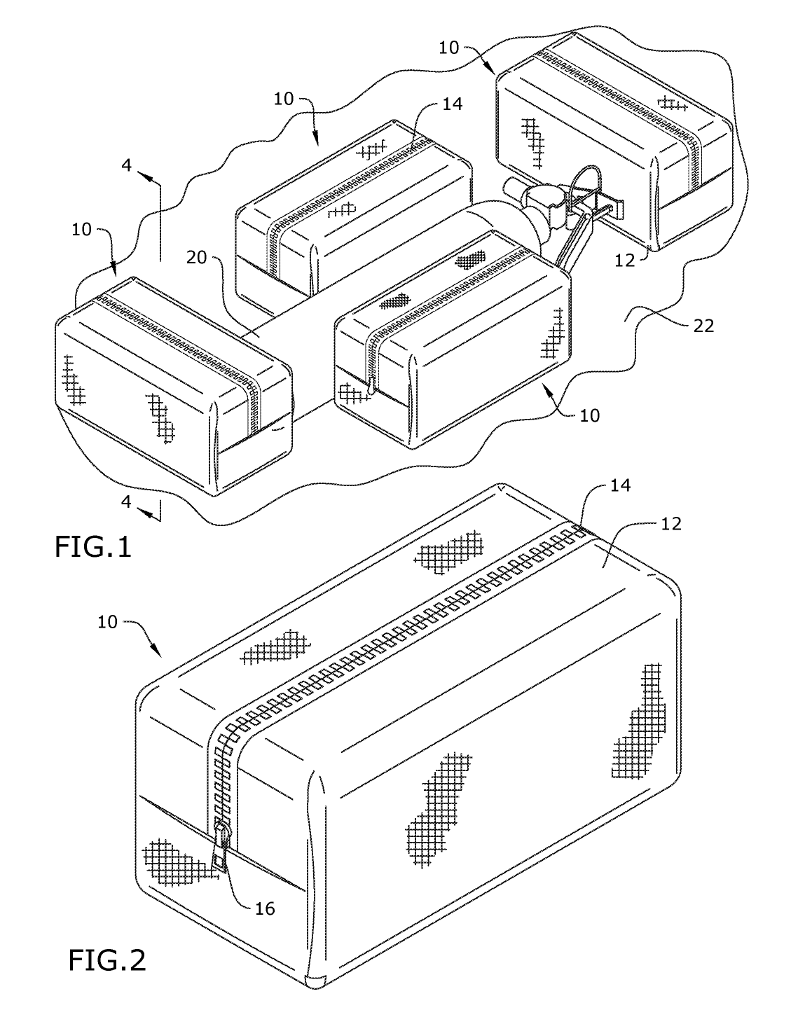

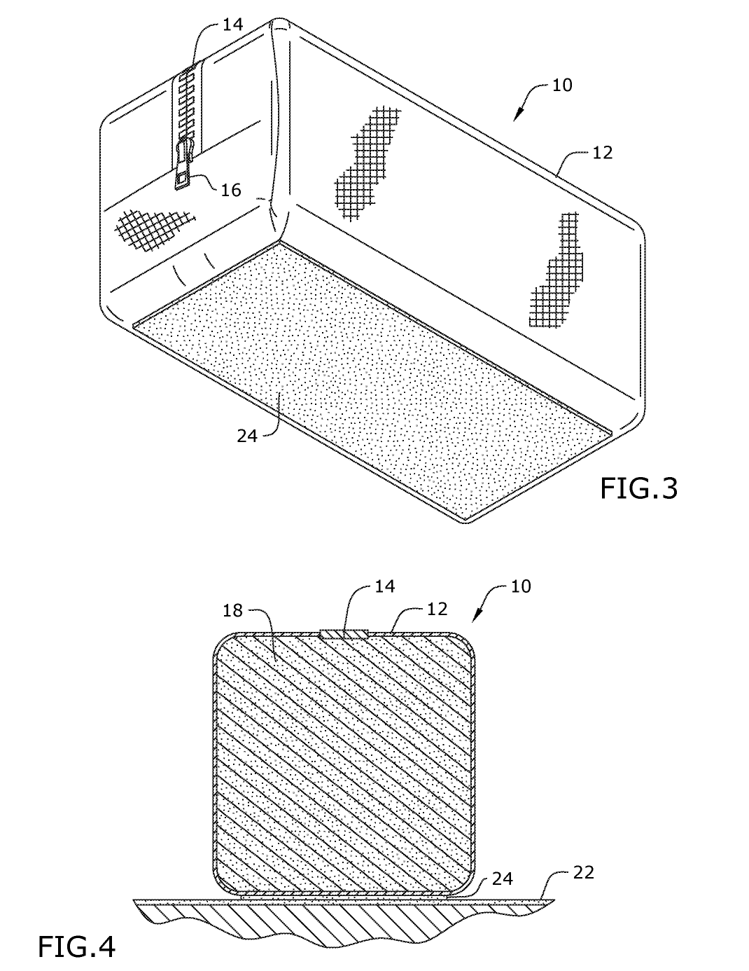

Referring now to FIGS. 1 through 4, the present invention may include a retaining device 10. The retaining device 10 may include a shell 12 housing an insert medium 18. The shell 12 may define an internal compartment dimensioned and adapted to snugly receive the inset medium 18. The shell 12 may provide an opening movable from a closed condition to an open condition communicating to the internal compartment. A detachable closure mechanism 14 may be provided along a periphery of the opening for detachably securing said opening in the closed condition, securing the insert medium within the internal compartment. A removable fastener 24 may be disposed along an outer portion of the shell 12. The present invention may incorporate the retaining device 10 in a method for securely retaining at least one predetermined object 20 within a moving vehicle 22.

The shell 12 may be made of any material that can provides suitable resiliency and strength. The suitable material may include but not limited to polymeric material, canvas and the like. The shell 12 may be formed by sewing or stitching of a unitary sheet of the suitable material so as to define the opening communicating with the internal compartment.

A handle (not shown) may be made of a suitable material so as to be thin and yet strong and resistant to elongating, including but not limited to polymeric material, canvas and the like. The handle may be attached to the shell 12 so as to facilitate the manual relocation of the retaining device 10.

The detachable closure mechanism 14 may be a zipper, flap or the like adapted to removably seal the opening. The detachable closure mechanism 14 may provide a tab 16 for moving the detachable closure mechanism 14 between the open and closed condition.

The removable fastener 18 may be affixed to the shell 12 with adhesive, rivets, stitching, or similar method of permanent attachment. The removable fastener 18 may be a hook and loop, hook and pile, VELCRO™ type fastener This removable fastener 18 will allow for quick attachment and removal of device 10 to an interior surface 22 of the vehicle, such as the interior liner.

The insert medium 18 used to fill and provide bulk to the pouch shell 12 may be high-density foam, sand bags, packing peanut bags, rags, expandable foam, or any other like sized medium that can be adapted to snugly fit within the internal compartment.

The method of using the present invention may include the following. The retaining device 10 disclosed will be provided. A user may place at least one retaining device 10 so as to abut the predetermined object 20 in a vehicle, whereby the removable fastener 18 securely attaches to an interior surface 22 of the vehicle so that the device 10 is positioned to block or trap the predetermined object 20 from at least one direction. This way, the present invention is “vehicle neutral”. In certain embodiments, the user may place the predetermined object 20 in a corner of the interior of the vehicle. Thus taking advantage of the adjacent sidewalls to facilitate retention of the predetermined object 20 in which the retaining device 10 acts as an opposing wall, preventing the predetermined object 20 from sliding or rolling around. The user may use a plurality of retaining devices 10 to facilitate such purposes, as illustrated in FIG. 1.

In an alternative embodiment, the use may provide a container, such as a crate, to hold a plurality of predetermined objects 20, while the container is retained by at least one retaining device 10.

It should be understood, of course, that the foregoing relates to exemplary embodiments of the invention and that modifications may be made without departing from the spirit and scope of the invention as set forth in the following claims.

What is claimed is:

1. A retaining device, comprising:
a shell defining an internal compartment and an opening communicating thereto;
a detachable closure mechanism provided along a periphery of the opening;
an insert medium snugly received in the internal compartment; and
a removable fastener disposed along an outer portion of the shell.

2. The retaining device of claim 1, further including a tab provided by the detachable closure for facilitating moving the opening between a closed condition and an open condition, making the internal compartment accessible.

3. The retaining device of claim 1, wherein the insert medium comprises expandable foam.

4. The retaining device of claim 1, wherein the removable fastener is a hook and loop fastener.

5. A retaining device, comprising:
a shell defining an internal compartment and an opening communicating thereto;
a detachable closure mechanism provided along a periphery of the opening;
an expandable foam snugly received in the internal compartment;
a hook and loop fastener disposed along an outer portion of the shell; and
a tab provided by the detachable closure for facilitating moving the opening between a closed condition and an open condition, making the internal compartment accessible.

6. A method of retaining a predetermined object within a moving vehicle, comprising the steps of:
providing a first retaining device of claim 1;
selectively positioning the first retaining device so as to abut a first side of the predetermined object; and
securing a first removable fastener to an internal surface of the vehicle, wherein the internal surface operatively engages the removable fastener.

7. The method of claim 6, further comprising the steps of:
providing a second retaining device of claim 1;
selectively positioning the second retaining device so as to abut a second side of the predetermined object opposing the first side thereof; and
securing a second removable fastener to the internal surface.

8. The method of claim 6, further comprising the steps of initially placing the predetermined object so that second side of the predetermined object, opposing the first side thereof, abuts a structure of the vehicle.

9. The method of claim 6, further comprising the steps of repeating the selectively positioning and securing of a second and further retaining devices of claim 1 so that each retaining device of claim 1 abuts a plurality of sides of the predetermined object.
